(19) United States
(12) Patent Application Publication
(10) Pub. No.: US 2004/0189609 A1
(43) Pub. Date: Sep. 30, 2004

(54) Optical pointing device and method therefor

(76) Inventors: Charles D. Estes, Ft. Lauderdale, FL (US); Shahid B. Khan, Tamarac, FL (US); Geydi Lorenzo, Miramar, FL (US)

Correspondence Address: AKERMAN SENTERFITT, P.O. BOX 3188, WEST PALM BEACH, FL, 33402-3188, US

(21) Appl. No.: 10/396,039

(22) Filed: Mar. 25, 2003

(51) Int. Cl. G09G 5/00

(52) U.S. Cl. 345/169

(57) ABSTRACT

A mobile pointing device includes a portable communication device (10) having an optical sensor (40) integrated in the portable communication device, a display (12) on an opposing side of the optical sensor, and a processor (16). The processor can be programmed to operate the optical sensor as a camera in a first mode (74) and as a mobile pointing device in a second mode (80 or 82) for the portable communication device itself or for an external computing device (52).

### CROSS-REFERENCE TO RELATED APPLICATIONS

Not applicable

1. Field of the Invention

This invention relates generally to pointing devices, and more particularly to a method and system for using an optical sensor in a portable communication device as a pointing device for the portable communication device or for an external computing device.

2. Background of the Invention

Most cellular phones fail to include sufficient or adequate pointing devices. Although some higher-end smart phones use touch screens to enable navigation through text and menus, most phones use cumbersome navigation keys and are restricted for navigation on a display or screen of the phone itself. If a separate computing device such as a laptop or personal digital assistant (PDA) or smart phone requires a pointing device, then additional hardware in the form of a mouse is usually needed.

A pointing device such as a mouse comes in many forms. There are conventional mice that use balls and wheels to navigate through screens and menus. Most mice include buttons to “right-click” or “left-click” to provide additional functionality. There are mice that include optical sensors such as mice by Targus that do not use conventional ball and wheels. Then, there are cordless mice by Logitech for example that use radio frequency links to enable the operation of a pointing device wirelessly. Some mice may have even adopted the Bluetooth standard for a wireless connection between the mouse and a corresponding computing device. Again, these are additional devices that someone having a mobile office would typically carry.

Some cellular phones in the marketplace are now including a small integrated camera. The camera is primarily used for taking still photos for subsequent transmission over-the-air. Some cameras in cellular phones are also used for video as well. The cameras are not integrally linked to the user interface of the functional display of the phones nor do they operate or link to user interfaces of other external devices.

### SUMMARY OF THE INVENTION

A method and apparatus for providing a pointing device in a portable communication device can take advantage of optical sensors in existing products to provide additional functionality.

In a first aspect of the present invention, a mobile pointing device comprises a portable communication device having an optical sensor integrated therein, a display on an opposing side of the optical sensor, and a processor. The processor can be programmed to operate the optical sensor as a camera in a first mode and as a mobile pointing device in a second mode.

In a second aspect of the present invention, a portable communication device comprises an optical sensor integrated in the portable communication device and a processor programmed to operate the optical sensor as a camera in a first mode and as a mobile pointing device in a second mode. The portable communication device can further comprise a display on an opposing side of the optical sensor.

In a third aspect of the present invention, a method of using a portable communication device having an integrated optical sensor comprises the steps of determining if the integrated optical sensor is operating in a camera mode or a pointing device mode and, if operating in the pointing device mode, operating the integrated optical sensor as a pointing device for an external computing device if the portable communication device is coupled to the external computing device and otherwise operating the integrated optical sensor as a pointing device for the portable communication device. The method can further include the step of user selectively operating the integrated optical sensor as one among the pointing device for the external computing device or the pointing device for the portable communication device or neither.

### BRIEF DESCRIPTION OF THE DRAWINGS

FIG. 1 is a front perspective view of a portable communication device having an optical sensor and an open flip in accordance with the present invention.

FIG. 2 is a rear perspective view of the portable communication device of FIG. 1.

FIG. 3 illustrates a block diagram of a system using a portable communication device as a pointing device for an external computing device in accordance with the present invention.

FIG. 4 illustrates a flow chart of a method of using a portable communication device having an optical sensor in accordance with the present invention.

### DETAILED DESCRIPTION OF THE DRAWINGS

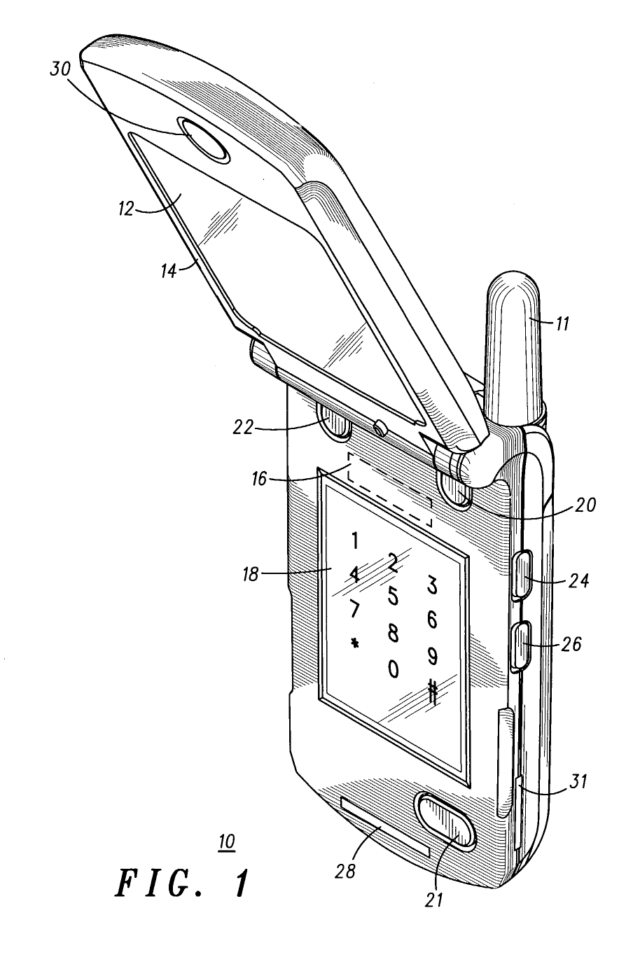

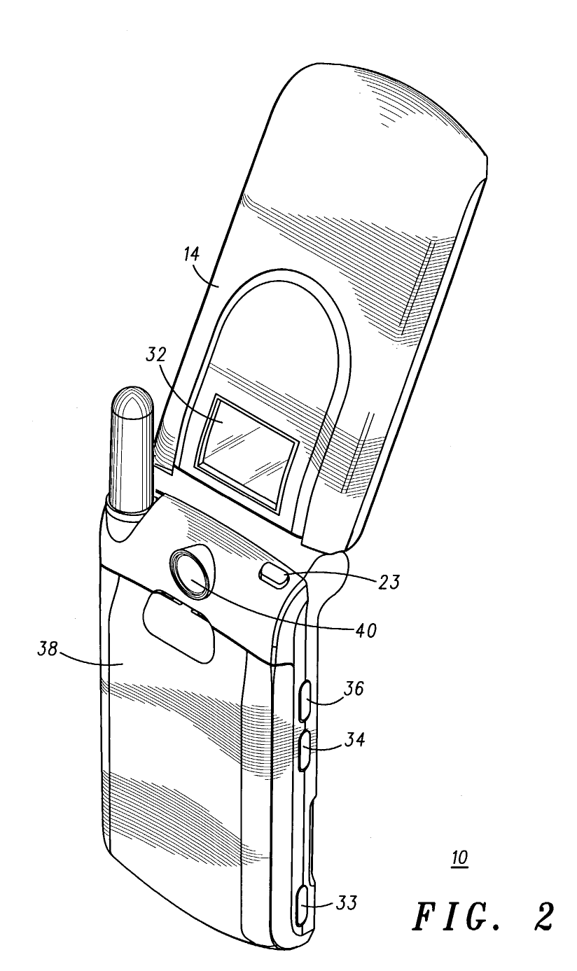

Referring to FIGS. 1 and 2, a mobile pointing device or portable communication device 10 such as a cellular phone can include a transceiver radio having an antenna 11, a microphone 28, an earpiece 30, an integrated keypad 18 and a display 12 (such as a color display) coupled to the transceiver radio. The portable communication device 10 further includes at least one integrated optical sensor 40 and a processor 16. The display 12 can reside on an opposing side of the optical sensor as shown. The portable communication device can also include other keys or buttons for powering the device on and off (21), for sending a call (20), or for terminating a call (22). Button 24 can operate as a “left-click” and button 26 can operate as a “right-click” when the portable communication device is operating in a pointing device mode. An additional button 23 can be used to change the mode of the portable communication device from a pointing device mode, a camera mode or a normal mode regardless of whether the flip is up or down. Of course, alternative embodiments of the present invention contemplates configuring other keys (including any of the keys, buttons or keypads previously mentioned) to provide this mode switching function if desired. For example, multiple keys can provide this function such that at least a first accessible key is available when the flip is closed and covering the display and at least a second accessible key is available when the flip is opened and exposing the display. Additionally, the particular functions assigned to keys described above are merely illustrative and can be reassigned to achieve a desired ergonomic result within contemplation of the present invention. For example, keys 22 and 20 can also serve as the “left-click” and “right-click” keys respectively when the flip is open and the portable communication device is operating in the pointing device mode. When the flip is closed, keys 24 and 26 can serve as the “left-click” and “right-click” keys respectively as previously described which is oriented for a right-handed person, but these keys can be re-assigned or functionally exchanged with keys 34 and 36 to be more ergonomically suited for a left-handed person if desired.

The portable communication device 10 can be a flip-phone having a flip 14, although the invention can be embodied in other form factors such as a monolith-shaped phone without a flip. In the embodiment shown, the flip 14 carries not only the display 12 on one side of the slip, but also a second smaller display 32 on an opposing side of the flip 14. As shown in the rear perspective view of FIG. 2, the portable communication device can also include a battery pack 38 for powering the device as well as additional buttons providing a push-to-talk function (33), an increase volume function (36), and a decrease volume function (34).

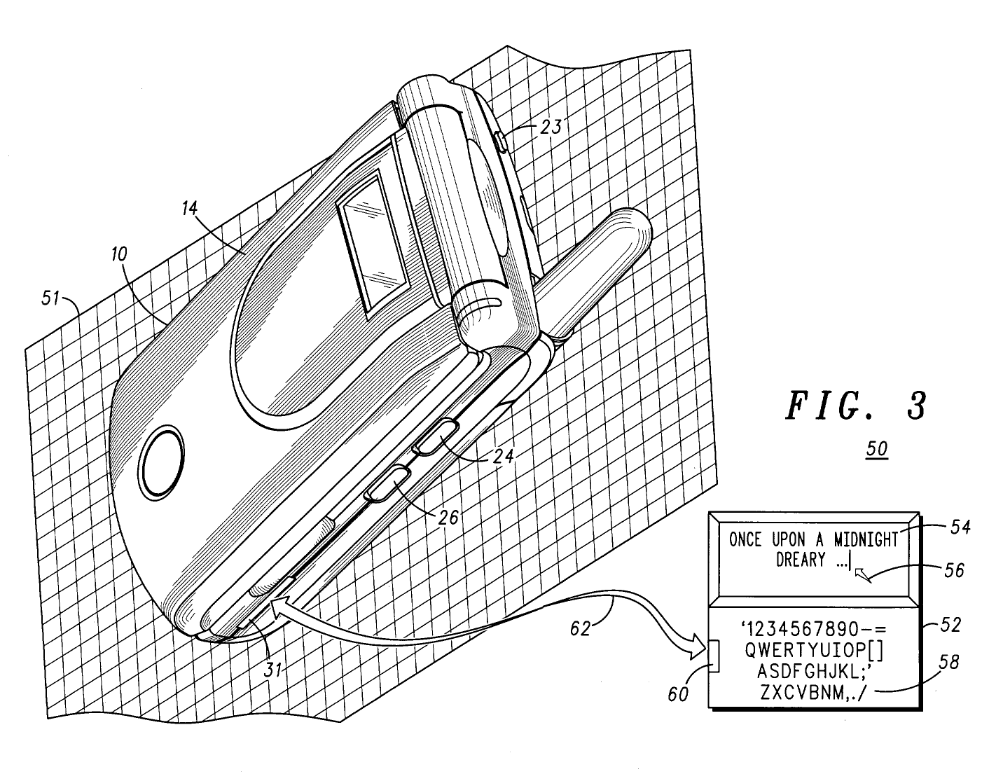

The portable communication device or mobile pointing device 10 can further include a port 31 or interface serving to provide an interconnection 62 between the portable communication device 10 and an external computing device 52 as shown in the system 50 of FIG. 3. The external computing device 52 can be a laptop computer, PDA, smartphone, a digital tablet or other computing device. The external computing device can include a keyboard 58, a display 54, and a mating interface 60 for the interconnection 62. The interconnection 62 can be a wired serial or parallel connection or a wireless connection such a Bluetooth interface connection. When operating in as a pointing device, the portable communication device 10 can control a pointer 56 and cursor on the display 54 of the external computing device 54. Although not necessarily required, the optical sensor 40 would likely operate best on a mouse-pad or other surface 51 that can provide reference points as opposed to a smooth plain surface or a glass surface.

Operationally, the processor 16 is programmed to operate as a camera in a first mode and as a pointing device in a second mode. In one embodiment, the portable communication device operates in the second mode as a pointing device for the portable communication device itself when the flip is open and as a pointing device for an external computing device when the flip is closed. In other words, the processor can be programmed to operate in the second mode as a pointing device for the portable communication device in a first sub-mode of the second mode and as a pointing device for an external computing device in a second sub-mode of the second mode. In the first sub-mode, the pointing device (10) moves a cursor and/or pointer on the display 12 of the portable communication device 10.

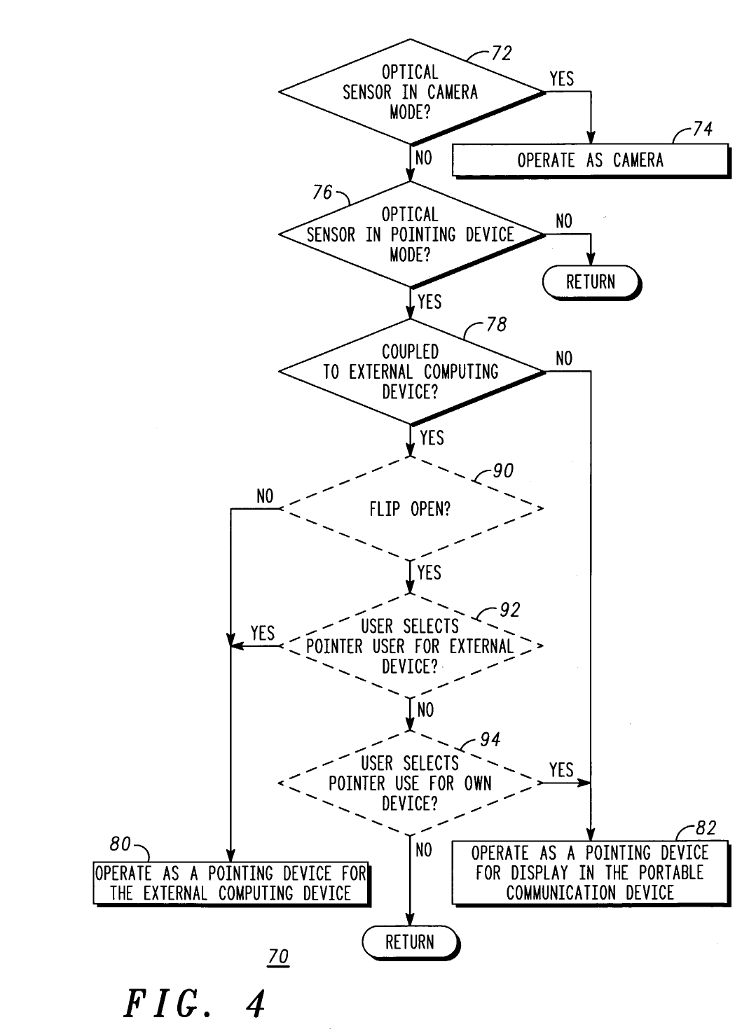

Referring to FIG. 4, a flow chart illustrates a method 70 of using a portable communication device having an integrated optical sensor as a pointing device. The method 70 can begin by determining if the integrated optical sensor is operating in one among a camera mode and a pointing device mode. As shown at decision block 72, if the optical sensor is operating in a camera mode, then the optical sensor operates as a camera at step 74. If not, then the method determines at decision block 76 whether the optical sensor is operating in a pointing device mode. If the optical sensor is not operating in a pointing device mode, then the method 70 returns to normal operation. If the optical sensor is operating in a pointing device mode, then a further inquiry is made at decision block 78 to determine if the portable communication device is coupled to an external computing device. If no external device is detected at decision block 78, then at step 82 the optical sensor can operate as the pointing device for a display in the portable communication device. If an external computing device is detected at decision block 78, then the portable communication device can operate as a pointing device for the external computing device at step 80.

Optionally, as indicated by the dashed decision blocks (90, 92 and 94), if the portable communication device includes a flip, then additional inquiries can be made. For example, even after determining that the portable communication device is coupled to the external computer device at decision block 78, a further inquiry can be made to determine if the flip is open. If the flip is not open at decision block 90, then the portable communication device can operate as the pointing device for the external computing device at step 80. If the flip is open at decision block 90, then a further inquiry should be made at decision block 92 to determine if a user selected the pointing device mode for the external computing device. If so, then the method 70 goes to step 80 where the portable communication device can operate as the pointing device for the external computing device. If the user did not select the pointing device mode for the external device at decision block 92, then a further inquiry is made at decision block 94 as to whether the user selected the pointing device mode for the portable communication device itself. If the user selected the pointing device mode for the portable communication device, then the method proceeds to step 82 where the optical sensor can operate as the pointing device for the display in the portable communication device. If the flip is open at decision block 90 and the user fails to select a pointer device mode for either the external computing device at decision block 92 or the portable communication device at decision block 94, then the portable communication device returns to normal operation. This alternative embodiment demonstrates that a user can selectively enable the integrated optical sensor in the pointing device mode notwithstanding the portable communication device being coupled to the external computing device.

The method 70 illustrates the linking between the optical sensor and a user interface on the portable communication device or on an external computing device when the integrated optical sensor is operating in the pointing device mode.

In light of the foregoing description of the invention, it should be recognized that the present invention can be realized in hardware, software, or a combination of hardware and software. A method and system for an optical pointing device using a communication device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which, when loaded in a computer system, is able to carry out these methods. A computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

What is claimed is:

1. A mobile pointing device, comprising:
a portable communication device;
an optical sensor integrated in the portable communication device;
a display on an opposing side of the optical sensor; and
a processor programmed to operate the optical sensor as a camera in a first mode and as a mobile pointing device in a second mode.

2. The mobile pointing device of claim 1, wherein the portable communication device further includes at least one integrated keypad.

3. The mobile pointing device of claim 1, wherein the portable communication device further comprises an interconnection between the portable communication device and an external computing device.

4. The mobile pointing device of claim 3, wherein the interconnection is selected from the group comprising a wireless connection, a wired serial connection, and a wired parallel connection.

5. The mobile pointing device of claim 1, wherein the portable communication device further comprises a flip that covers the display and further comprises at least one accessible button when the flip covers the display.

6. The mobile pointing device of claim 1, wherein the portable communication device further comprises a flip and at least a first accessible key when the flip is closed and covering the display and at least a second accessible key when the flip is opened and exposing the display.

7. The mobile pointing device of claim 6, wherein the processor is programmed to operate in the second mode as a pointing device for the portable communication device when the flip is open and as a pointing device for an external computing device when the flip is closed.

8. The mobile pointing device of claim 6, wherein the processor is programmed to operate in the second mode as a pointing device for the portable communication device in a first sub-mode of the second mode and as a pointing device for an external computing device in a second sub-mode of the second mode.

9. The mobile pointing device of claim 8, wherein the pointing device moves a cursor on the display of the portable communication device in the first sub-mode.

10. The mobile pointing device of claim 8, wherein the external computing device is selected from the group comprising a laptop computer, a desktop computer, a personal digital assistant, and a digital tablet.

11. The mobile pointing device of claim 1, wherein the portable communication device is a cellular phone.

12. A portable communication device, comprising:
an optical sensor integrated in the portable communication device; and
a processor programmed to operate the optical sensor as a camera in a first mode and as a mobile pointing device in a second mode.

13. The portable communication device of claim 12, wherein the portable communication device further comprises a display on an opposing side of the optical sensor.

14. The portable communication device of claim 12, wherein the portable communication device further comprises an interconnection between the portable communication device and an external computing device.

15. The portable communication device of claim 13, wherein the portable communication device further comprises a flip and at least a first key when the flip is closed and covering the display and at least a second key when the flip is opened and exposing the display.

16. The portable communication device of claim 15, wherein the processor is programmed to operate in the second mode as a pointing device for the portable communication device when the flip is open and as a pointing device for an external computing device when the flip is closed.

17. The portable communication device of claim 13, wherein the processor is programmed to operate in the second mode as a pointing device for the portable communication device in a first sub-mode of the second mode and as a pointing device for an external computing device in a second sub-mode of the second mode.

18. A method of using a portable communication device having an integrated optical sensor, comprising the steps of:
determining if the integrated optical sensor is operating in one among a camera mode and a pointing device mode; and
operating the integrated optical sensor as a pointing device for an external computing device if the portable communication device is coupled to the external computing device and operating in the pointing device mode and otherwise operating the integrated optical sensor as a pointing device for the portable communication device if the portable communication device is operating in the pointing device mode.

19. The method of claim 18, wherein the method further comprises the step of user selectively operating the integrated optical sensor as one among the pointing device for the external computing device and the pointing device for the portable communication device.

20. The method of claim 18, wherein the method further comprises user selectively enabling the integrated optical sensor in the pointing device mode notwithstanding if the portable communication device is coupled to the external computing device.

21. The method of claim 18, wherein the method further comprises linking the optical sensor to a user interface on the portable communication device if the integrated optical sensor is operating in the pointing device mode.
